(19) United States
(12) Patent Application Publication
(10) Pub. No.: US 2018/0012131 A1
(43) Pub. Date: Jan. 11, 2018

(54) PREDICTING AN EFFECT OF A SET OF MODIFICATIONS TO AN APPEARANCE OF CONTENT INCLUDED IN A CONTENT ITEM ON A PERFORMANCE METRIC ASSOCIATED WITH THE CONTENT ITEM

(71) Applicant: Facebook, Inc., Menlo Park, CA (US)

(72) Inventor: Erick Tseng, San Francisco, CA (US)

(21) Appl. No.: 15/204,732

(22) Filed: Jul. 7, 2016

(51) Int. Cl. G06N 5/04; G06T 11/60; G06N 99/00

(52) U.S. Cl. CPC G06N 5/04; G06N 99/005; G06T 11/60

(57) ABSTRACT

An online system receives a request from a user of the online system to generate a content item specifying content (e.g., an image) received from the user and one or more modifications to the appearance of the content to be included in the content item. The online system generates multiple instances of the content item based on the request, in which each instance includes a different set of the specified modifications. Using an identifier that identifies each instance based on the set of modifications to the appearance of the included content (e.g., using an image fingerprint), the online system tracks a performance metric associated with each instance. By comparing the performance metrics associated with the instances, the online system identifies one or more modifications responsible for one or more differences between the performance metrics and predicts an effect on the performance metrics associated with content item instances including the identified modifications.

### BACKGROUND

This disclosure relates generally to online systems, and more specifically to predicting the effect that a set of modifications of the appearance of content included in a content item has on a performance metric associated with the modified content item.

An online system allows its users to connect and communicate with other online system users. Users create profiles on the online system that are tied to their identities and include information about the users, such as interests and demographic information. The users may be individuals or entities such as corporations or charities. Because of the popularity of online systems and the significant amount of user-specific information maintained by online systems, an online system provides an ideal forum for allowing users to share content by creating content items for presentation to additional online system users. For example, users may share photos or videos they have uploaded by creating content items that include the photos or videos that are presented to additional users to which they are connected on the online system. An online system also provides advertisers with abundant opportunities to increase awareness about their products or services by presenting advertisements to online system users. For example, advertisements presented to users allow an advertiser to gain public attention for products or services and to persuade online system users to take an action regarding the advertiser's products, services, opinions, or causes.

Conventionally, online systems generate revenue by displaying content items, such as advertisements, to their users. For example, an online system may charge advertisers for each presentation of an advertisement to an online system user (i.e., each “impression”), or for each interaction with an advertisement by an online system user. Furthermore, by presenting content items that encourage user engagement with online systems, online systems may increase the number of opportunities they have to generate revenue. For example, if a user scrolls through a newsfeed to view content items that capture their interest, advertisements that are interspersed in the newsfeed may be presented to the user. Therefore, online systems may maximize their revenue by presenting high-quality content items (e.g., advertisements and other types of content items in which users are likely to have an interest and with which users are likely to interact).

Online systems may collect information describing the performance of content items presented to online system users. For example, if a user of an online system logs into their online system account and creates a content item, the online system presents the content item to users of the online system (“viewing users”) and stores information describing each interaction it receives from a viewing user with the content item. This information may be compiled and presented in conjunction with the content item. For example, a content item may include a number of viewing users who expressed a preference for, commented on, or shared the content item, as well as information describing the users performing the actions, the comments, etc.

Furthermore, online systems may analyze the collected information to identify high-quality content items, and/or to provide users associated with the content (e.g., advertisers) with information that may be used to improve the quality of their content items. For example, by analyzing data collected about user interactions with a content item, an online system may determine a performance metric associated with the content item (e.g., a click-through rate, a number of users who expressed a preference for the content item, etc.). The performance metric may be communicated to the user that created the content item. For example, an online system may generate and communicate a report to an advertiser that includes a side-by-side comparison of a number of conversions achieved by each advertisement in a campaign presented on the online system. By providing such information to users who create content items, the users providing the content items may better understand how they may go about improving the quality of their content items.

Both online systems and users who generate content items for presentation on online systems stand to gain from the presentation of high-quality content items. For example, an online system may earn revenue each time a user of the online system clicks on an advertisement that is priced using a cost-per-click pricing scheme, and advertisers stand to make a profit if their advertisements ultimately lead to conversions. Other users who generate content items may be motivated to create high-quality content items as well. For example, users may be motivated to generate posts that are shared excessively amongst online system users (i.e., “go viral”) to become Internet sensations, or at the very least, for bragging rights. Therefore, users generally are receptive to using any insights that may be gained from performance metrics to improve the quality of their content items.

However, users who create content items may upload content to be included in content items without logging into the online system, making it difficult to report on the performance of the content items. For example, if a user does not log in to the online system when uploading a color photograph of the Golden Gate Bridge and creates a content item that includes the color photograph, the online system will not be able to associate the content item with the user and hence, will not be able to provide any performance metrics associated with the content item to the user. Similarly, failure to log in to the online system also makes it difficult for the online system to report on instances of a content item that include modifications to content included in the content item. For example, if the user in the above example creates an instance of the content item that includes a modified version of the photograph (e.g., a black and white version), the online system will not be able to associate that instance with the user either. Thus, in these and other circumstances, online systems may have difficultly providing information that may help improve the quality of content items presented to users, which may be detrimental to the online systems and their users.

### SUMMARY

An online system receives content (e.g., images, text, etc.) from users of the online system (“content-providing users”) and provides a tool that enables the content-providing users to submit requests to generate content items (e.g., advertisements) that may include the content. For example, a content-providing user may use the tool to request to generate a content item that includes a photograph uploaded by the content-providing user and text describing the photograph. The tool may include various features enabling content-providing users to modify the content to be included in content items. For example, content-providing users may crop photographs with a cropping feature and alter colors in the photographs with a filter feature. Features of the tool also may allow content-providing users to change the size, color, or placement of text or other elements included in the content, or perform any other suitable modification to the appearance of the content. For example, features of the tool may allow a content-providing user to modify an image of a bouquet of roses that includes text, such that the content-providing user may change the color of the roses from pink to red and change the text from print to cursive.

Using the tool, content-providing users may request to generate multiple versions (i.e., instances) of a content item by specifying one or more modifications to the content included in the content item, in which each instance includes a different set of the specified modifications. For example, the online system may generate two instances of an advertisement for a car requested by an advertiser that differ only in a photograph of the car included in each instance—one instance includes a photograph of the car taken in the daytime, while the other instance includes the same photograph of the car that was modified using a filter that makes the photograph appear to have been taken in the evening. In some embodiments, if a content-providing user of the online system requests to generate a content item and uses a feature of the tool to specify a modification to content to be included in the content item, the online system may generate the requested instance of the content item and also automatically generate an additional instance of the content item that includes the content absent the modification (i.e., a control instance of the content item). For example, when the online system generates an instance of an advertisement that includes an image that was cropped at the request of an advertiser, the online system automatically generates another instance of the advertisement that includes the uncropped image. In this example, if the advertiser also requests to modify the image using a filter feature of the tool, the online system also may generate an instance of the advertisement that includes the cropped unfiltered image and another instance of the advertisement that includes the uncropped filtered image.

The online system uniquely identifies each instance of a content item, based, e.g., on the set of modifications to the appearance of content included in the instance. The online system may use various techniques to identify each instance of a content item. Examples of such techniques include using an image fingerprint, an image hash, a digital watermark, or any other suitable identifier that allows different sets of modifications to an appearance of content, and hence, different instances of a content item including the different sets of modifications to the appearance of the content, to be uniquely identified. For example, the online system embeds a digital watermark into an image included in a content item, in which the digital watermark includes an identification code that allows the instance to be uniquely identified based on an absence of any modifications to the appearance of the image. If a content-providing user of the online system crops the image in this example, the online system may embed a different digital watermark into the cropped image that uniquely identifies the instance based on the cropping of the original image.

In some embodiments, identifiers used to identify instances of a content item based on modifications to the appearance of their content may have a measure of similarity that is proportional to the degree to which their content was modified, such that the online system may identify different instances of a content item based on similarities between their associated identifiers. For example, the online system may apply a hash function to two different versions of an image (e.g., an original image and a modified image) included in different instances of a content item and compute an image hash for each version of the image based on the image's visual appearance (e.g., based on differences between adjacent pixel values). In this example, the degree of similarity between the image hashes is proportional to the degree of similarity between the appearances of the versions of the image, such that the online system may identify the instances including the versions of the image as instances of the same content item if their corresponding image hashes have at least a threshold measure of similarity to each other. Furthermore, in some embodiments, different instances of a content item may be identified with the same identifier. For example, since images that are very similar (e.g., the same image saved using different formats or resolutions or containing minor corruptions) may hash to the same image hash, instances of a content item including very similar images may be identified with the same identifier. An identifier used to identify an instance of a content item may be stored in association with information describing modifications to the appearance of the content to which they are associated and/or in association with the instance of the content item including the modifications to the appearance of the content.

The online system presents each instance of a content item to viewing users of the online system and tracks its performance so that the performances of different instances of the content item may be compared to each other. In some embodiments, instances of the content item are presented to similar groups of viewing users (e.g., viewing users having at least a threshold measure of similarity to each other or satisfying the same targeting criteria). The online system may collect data about one or more metrics describing the performance of each instance of a content item (i.e., performance metrics) using the identification technique. For example, the online system receives data about click-through rates for multiple advertisements during a specified period of time and identifies data about different instances of an advertisement based on digital watermarks associated with the data that match the digital watermarks associated with the different instances of the advertisement.

The online system compares values of one or more performance metrics associated with different instances of a content item to each other and identifies one or more modifications to the content included in some of the instances of the content item to which differences in the values of the performance metrics may be attributable. The online system may use A/B testing or any other suitable method of comparison to compare the values of the performance metrics between instances. For example, the online system uses A/B testing to compare the number of comments on two different instances of a content item, in which the instances differ only in one aspect (e.g., font color or placement of text included in their content). In this example, if the difference in the number of comments is at least a threshold number, the online system determines that the difference is likely attributable to the single aspect in which the instances differ.

As an additional example, the online system ranks multiple instances of an advertisement for a car based on their click-through rates (as the performance measure), in which the instances differ only in the color of the car in an image included in the instances. In this example, the online system determines an amount of variation in the click-through rate performance metric (e.g., based on a standard deviation or variance). If the amount of variation is at least a threshold amount, the online system identifies the color of the car to be the modification to which the variation in click-through rate is likely to be attributable.

Based on the difference in the values of the one or more performance metrics, the online system may predict the effect that the one or more modifications identified as being responsible for the difference will have on a value of the one or more performance metrics associated with content item instances including the one or more modifications. The prediction may be based on a correlation between the identified modifications and the content included in different instances of the content item and values of the performance metrics of the different instances of the content item. For example, if text is placed at the top of content included in one instance of a content item and the same text is placed at the bottom of the content included in another instance, and the former has a 10% higher click-through rate than the latter, the online system may predict a 10% improvement in the click-through rates of instances of the content item in which the text is placed at the top of the included content. In embodiments in which the online system ranks instances of a content item based on their associated performance metric values, the online system may predict the effect that the identified modifications have on the performance of instances of the content item including the modifications, based on the ranking and the amount of variation in the values. For example, if the online system ranks instances of a content item including an image of a t-shirt based on the rate at which the instances were shared, in which the instances differ only in the color of the t-shirt in the image included in the instances, the online system predicts that modifying the color of the t-shirt to that of the highest ranked instance will improve the rate at which the content item will be shared.

The prediction may be expressed at various levels of granularity of modification to the content. For example, the online system may predict the cumulative effect of multiple modifications made to content included in a content item (e.g., the effect of multiple filters applied to a photograph using a filter feature). Alternatively, the online system may predict the effect of each filter applied to the photograph on an individual basis. In some embodiments, the online system may predict the effect of a modification on the performance of a content item using a machine-learned model, as known in the art. For example, the online system may predict that applying a particular filter to an image included in the content item will result in an 8% increase in the conversion rate for the content item based on the average of conversion rates for instances of the content item that included content that was modified using the filter and conversion rates for content items including similar content that was modified using the filter.

The predicted effect of the modifications may be communicated to content-providing users who requested to generate the content item instances, to help the content-providing users improve the quality of their content items. In some embodiments, the online system may suggest that content-providing users incorporate particular modifications to the content in the content items, and provide an explanation of the likely impact on one or more performance metrics corresponding to the suggested modification. For example, the online system may inform the content-providing user who requested to generate a content item that adoption of only the instance of the content item that achieved the best performance metrics will likely result in a 12% higher rate at which viewing users will express a preference for the content item than for other instances of the content item. The online system may suggest that content-providing users use certain features of the tool to modify the content in the content items based on the predicted effect of modifications made using the features and provide previews of instances of the content items that have been modified with the features. For example, the online system may suggest that a content-providing user use a crop feature of the tool to crop a photograph to be included in a content item and provide a preview of the content item including the cropped photograph.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for predicting an effect of one or more modifications to an appearance of content included in instances of a content item on a performance metric associated with the content item, in accordance with an embodiment.

FIG. 4 is a conceptual diagram of a method for generating and storing unique identifiers associated with multiple instances of a content item, in accordance with an embodiment.

FIG. 5A is a conceptual diagram of a method for identifying a set of modifications to an appearance of content included in a pair of instances of a content item to which a difference between values of a performance metric associated with the instances of the pair is attributable, in accordance with an embodiment.

FIG. 5B is an additional conceptual diagram of a method for identifying a set of modifications to an appearance of content included in a pair of instances of a content item to which a difference between values of a performance metric associated with the instances of the pair is attributable, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

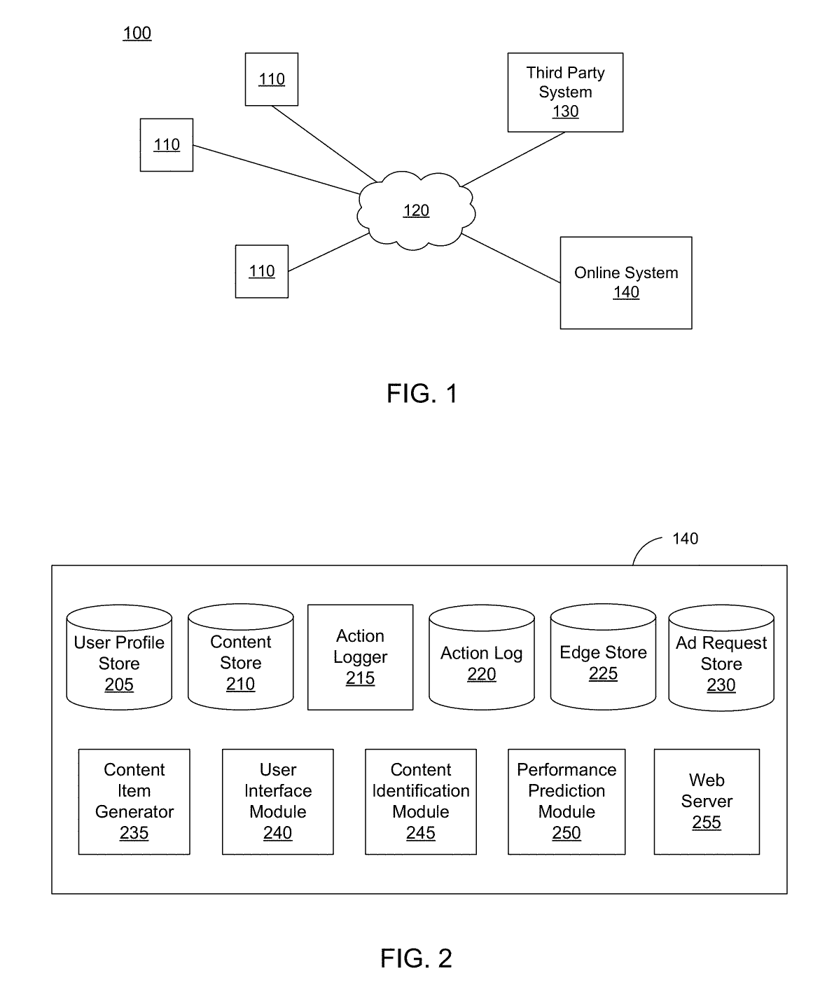

FIG. 1 is a block diagram of a system environment 100 for an online system 140. The system environment 100 shown by FIG. 1 comprises one or more client devices 110, a network 120, one or more third party systems 130, and the online system 140. In alternative configurations, different and/or additional components may be included in the system environment 100. The embodiments described herein may be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

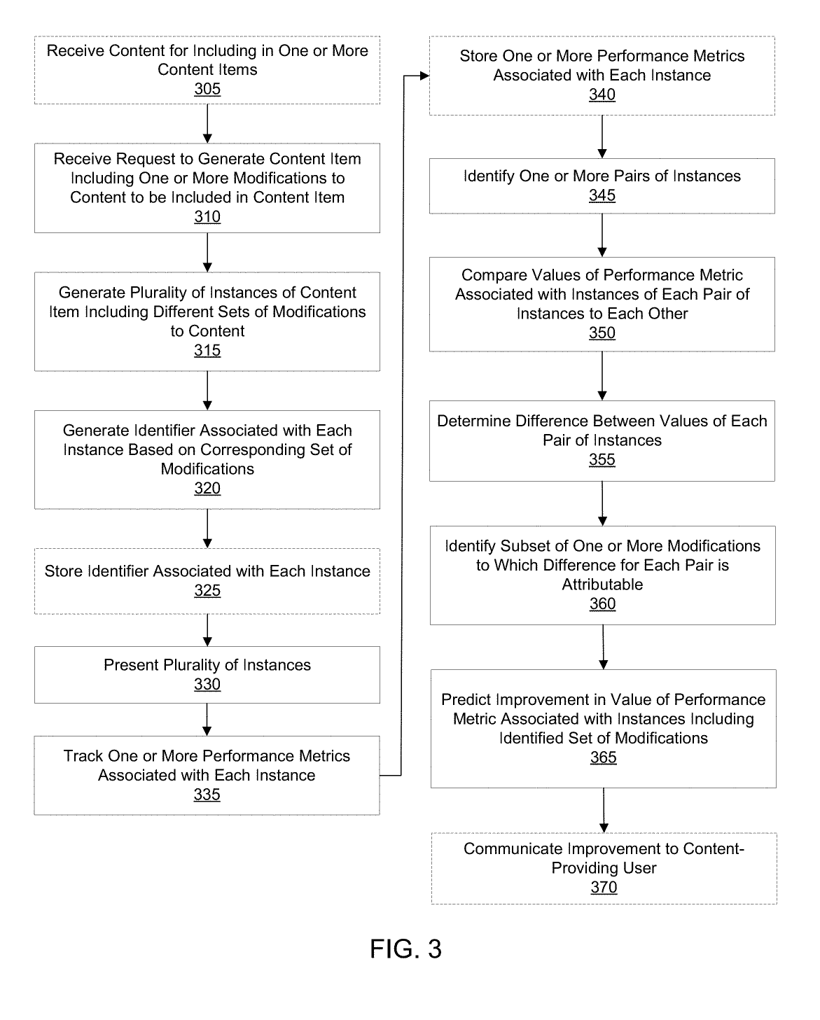

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 also may communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, an ad request store 230, a content item generator 235, a user interface module 240, a content identification module 245, a performance prediction module 250, and a web server 255. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

While user profiles in the user profile store 205 are frequently associated with individuals, allowing individuals to interact with each other via the online system 140, user profiles also may be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

In some embodiments, the content store 210 also stores information associated with the content represented by the stored objects. In some embodiments, the content is stored in association with information identifying a user of the online system 140 associated with the content (e.g., the user that uploaded/modified the content) and information describing the content. For example, content uploaded by a user is stored in the content store 210 in association with a user identifier for the user, a date that the user uploaded the content, and a format and size of the content. As an additional example, if a first instance of a content item includes an image and a second instance of the content item includes a cropped version of the image, the first instance is stored in association with a first image hash that identifies the first instance based on an absence of any modifications to the appearance of the image and the second instance is stored in association with a second image hash that identifies the second instance based on the cropping of the image. Information describing performances of content items also may be stored in association with the content items in the content store 210. For example, values of performance metrics associated with content items (e.g., click-through rates, conversion rates, etc.) may be stored in association with the corresponding content items. Information stored in association with content in the content store 210 may be stored in one or more tables in the content store 210. For example, data stored in the content store 210 includes various tables, in which a table is specific to a content item and includes information describing each instance of the content item (e.g., an identifier, differences between the content included in each instance, etc.).

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on the third party system 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 also may store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 for storing in the action log 220 by the application for recordation and association with the user by the social networking system 140.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An ad request includes advertisement content, also referred to as an “advertisement,” and a bid amount. The advertisement is text, image, audio, video, or any other suitable data presented to a user. In various embodiments, the advertisement also includes a landing page specifying a network address to which a user is directed when the advertisement content is accessed. The bid amount is associated with an ad request by an advertiser and is used to determine an expected value, such as monetary compensation, provided by the advertiser to the online system 140 if an advertisement in the ad request is presented to a user, if a user interacts with the advertisement in the ad request when presented to the user, or if any suitable condition is satisfied when the advertisement in the ad request is presented to a user. For example, the bid amount specifies a monetary amount that the online system 140 receives from the advertiser if an advertisement in an ad request is displayed. In some embodiments, the expected value to the online system 140 for presenting the advertisement may be determined by multiplying the bid amount by a probability of the advertisement being accessed by a user.

Additionally, an ad request may include one or more targeting criteria specified by the advertiser. Targeting criteria included in an ad request specify one or more characteristics of users eligible to be presented with advertisement content in the ad request. For example, targeting criteria are used to identify users associated with user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria also may specify interactions between a user and objects performed external to the online system 140, such as on a third party system 130. For example, targeting criteria identifies users who have performed a particular action, such as having sent a message to another user, having used an application, having joined or left a group, having joined an event, having generated an event description, having purchased or reviewed a product or service using an online marketplace, having requested information from a third party system 130, having installed an application, or having performed any other suitable action. Including actions in targeting criteria allows advertisers to further refine users eligible to be presented with advertisement content from an ad request. As another example, targeting criteria identifies users having a connection to another user or object or having a particular type of connection to another user or object. For example, targeting criteria in an ad request identifies users connected to an entity, in which information stored in the connection indicates that the users are employees of the entity.

The content item generator 235 receives requests from content-providing users of the online system 140 to generate content items (e.g., advertisements) that may include content (e.g., images) received from the content-providing users. The requests may be received by the content item generator 235 via a tool provided by the online system 140 that enables content-providing users of the online system 140 to upload and/or specify content to be included in the content items. For example, the content item generator 235 receives a request from a content-providing user to generate a content item including a photograph and text describing the photograph, in which the photograph and the text were provided by the content-providing user using the tool.

The tool may include various features (e.g., filters) enabling content-providing users to modify an appearance of the content to be included in content items. Examples of features of the tool include features that allow content-providing users to crop the content, change the size, color, or placement of text or other elements included in the content, or perform any other suitable modification to the appearance of the content. For example, content-providing users may crop photographs with a cropping feature and alter colors in the photographs with a filter feature (e.g., change the photographs from color to black and white). As an additional example, features of the tool may allow a content-providing user to modify an image of a kitchen appliance, such that the content-providing user may change the color of the appliance from stainless steel to black and resize the image.

The content item generator 235 also may generate multiple instances of a content item based on a request received from a content-providing user to generate the content item. Each instance of the content item includes a different set of one or more modifications to the content included in the content item specified in the request received from the content-providing user. For example, the content item generator 235 may generate two instances of an advertisement for a car requested by an advertiser, in which one instance includes a photograph of the car taken in the daytime and the other instance includes the same photograph of the car that was modified using a filter that makes the photograph appear to have been taken at night. The instances of the content item may include one or more interactive elements that allow viewing users of the instances to perform actions associated with the instances (e.g., a “like” button, a “comment” button, a “share” button, etc.). For example, an instance of an advertisement for a product or service may include a “shop” button that allows viewing users who click on the button to be redirected to a third party website where they may purchase the product or service.

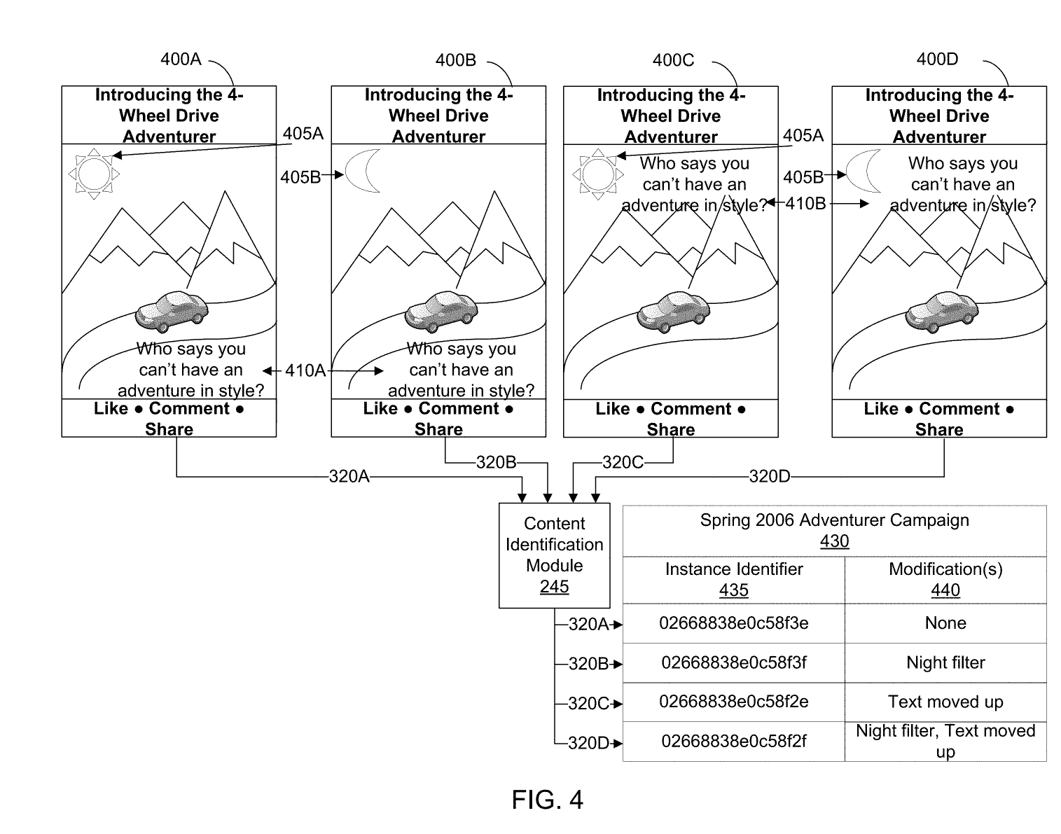

In some embodiments, if a content-providing user of the online system 140 uses a feature of the tool to modify content to be included in a content item, the content item generator 235 may generate an instance of the content item including the requested modification and also automatically generate an additional instance of the content item that includes the content absent the modification (i.e., a control instance of the content item). For example, if an advertisement includes an image that was cropped at the request of an advertiser, the content item generator 235 may automatically generate another instance of the advertisement that includes the original uncropped image. In this example, if the cropped image was subsequently filtered using a filter feature of the tool, the content item generator 235 also may automatically generate an instance of the advertisement that includes the cropped unfiltered image and another instance of the advertisement that includes the uncropped filtered image. As an additional example, if a content item includes content with text and a feature of the tool is used to change the location of the text from the right side of the content to the left, the content item generator 235 may generate an instance of the content that includes the text on the left side of the content and automatically generate another instance of the content item that includes the text in its original position on the right side of the content. The content item generator 235 is further described below in conjunction with FIG. 3.

The user interface module 240 generates and presents a user interface for the tool provided by the online system 140 that enables content-providing users of the online system 140 to submit requests to generate content items. For example, a content-providing user may interact with the tool via a window or page generated by the user interface module 240 presented in a display area of a client device 110 and submit a request to generate a content item (e.g., via buttons, drop-down menus, etc.). The user interface may include options allowing a content-providing user to upload content to be included in a content item and/or to select previously uploaded content to be included in the content item. For example, options in the user interface allow a content-providing user to upload a new photograph to the online system 140 or select a photograph from a list of photographs previously uploaded by the content-providing user to include in a content item. Content uploaded by a content-providing user may be stored in the content store 210 in association with information identifying the content-providing user that uploaded the content (e.g., username or user identification number) and information describing the content (e.g., size, format, date uploaded or modified, etc.). The user interface may include additional options corresponding to features of the tool provided by the online system 140. For example, features of the tool (e.g., filter, crop, resize, font color, etc.) correspond to tabs in the user interface and sub-features (e.g., filter types, cropping/resizing dimensions, colors, etc.) correspond to buttons within each tab.

In some embodiments, the user interface includes information based on one or more modifications to an appearance of content to be included in a content item specified in a request to generate the content item. For example, if the content item generator 235 receives a request to crop a photograph and generate a content item that includes the cropped photograph via the user interface, the user interface may include a display area that presents a preview of the requested content item. As an additional example, information presented in the user interface may inform a content-providing user that requested to generate multiple instances of a content item that adoption of only the instance of the content item that achieved the best performance metric values will likely result in a 12% predicted higher rate at which viewing users will express a preference for the content item over other instances of the content item. Additionally, information presented in the user interface may suggest that content-providing users use certain features of the tool to modify the content in the content items based on the predicted effect of modifications made using the features and provide previews of instances of the content items including content that has been modified with the features. For example, information included in the user interface may include a suggestion that a content-providing user use a crop feature of the tool to crop a photograph to be included in a content item and provide a preview of the content item including the cropped photograph.

The user interface module 240 also presents multiple instances of a content item generated by the content item generator 235 to viewing users of the online system 140. Instances of a content item may be displayed on client devices 110 associated with viewing users in a feed (e.g., a newsfeed), in a pop-up window, or via any other suitable method for presenting content. Instances of the content item may be presented to similar groups of viewing users. For example, each instance of the content item is presented to viewing users having at least a threshold measure of similarity to each other or viewing users who satisfy the same targeting criteria. In some embodiments, only one instance of each content item is presented to a viewing user of the online system 140. In other embodiments, multiple instances of a content item may be presented to the same viewing user. The user interface module 240 is further described below in conjunction with FIG. 3.

The content identification module 245 generates identifiers that identify different instances of a content item based on modifications to an appearance of content included in the instances. The content identification module 245 may use various techniques to generate identifiers that allow different sets of modifications to an appearance of content, and hence, different instances of a content item including the different sets of modifications to an appearance of the content, to be uniquely identified. Examples of such techniques include using an image fingerprint, an image hash, a digital watermark, or any other suitable identifier. For example, the content identification module 245 embeds a digital watermark into an image to be included in an instance of a content item, in which the digital watermark includes an identification code that allows the instance to be uniquely identified based on an absence of any modifications to the appearance of the image. If a user of the online system 140 crops the image in this example, the content identification module 245 may embed a different digital watermark into the cropped image that uniquely identifies the instance based on the cropping of the original image.

In some embodiments, identifiers used to identify instances of a content item based on modifications to an appearance of their content may have a measure of similarity that is proportional to the degree to which their content was modified. For example, the content identification module 245 may apply a hash function to two different versions of an image (e.g., an original image and a modified image) included in different instances of a content item and compute an image hash for each version of the image based on the image's visual appearance (e.g., based on differences between adjacent pixel values). In this example, the degree of similarity between the image hashes is proportional to the degree of similarity between the appearances of the versions of the image.

The content identification module 245 may store the identifier generated for each instance of a content item. In some embodiments, the content identification module 245 stores the identifiers in association with information describing modifications to the appearance of the content that to which they are associated and/or in association with the instances of the content item including the modifications to the appearance of the content (e.g., in the content store 210). For example, an identifier for a modified photograph is stored in association with information describing the modifications made to the photograph and an instance of a content item including the modified photograph in the content store 210.

The content identification module 245 tracks one or more performance metrics associated with each instance of a content item using the identifier associated with each instance. For example, the content identification module 245 receives data about click-through rates for instances of an advertisement during a specified period of time and identifies data about each instance of the advertisement based on digital watermarks associated with the data that match the digital watermark associated with each instance. In some embodiments, the content identification module 245 uses the same technique used to generate the identifier associated with an instance of a content item to identify values of performance metrics associated with the instance of the content item. For example, when the content identification module 245 receives information describing an interaction from a viewing user with an instance of a content item, the content identification module 245 applies the same hash function used to generate an identifier for the instance to the content included in the instance to determine the identifier for the instance. In this example, the content identification module 245 may then identify the instance with which the viewing user interacted based on its identifier (e.g., based on information associated with a matching identifier retrieved from the content store 210). Alternatively, the content identification module 245 may retrieve the identifier for the instance from a digital watermark embedded in the content included in the instance and identify the instance based on the identifier.

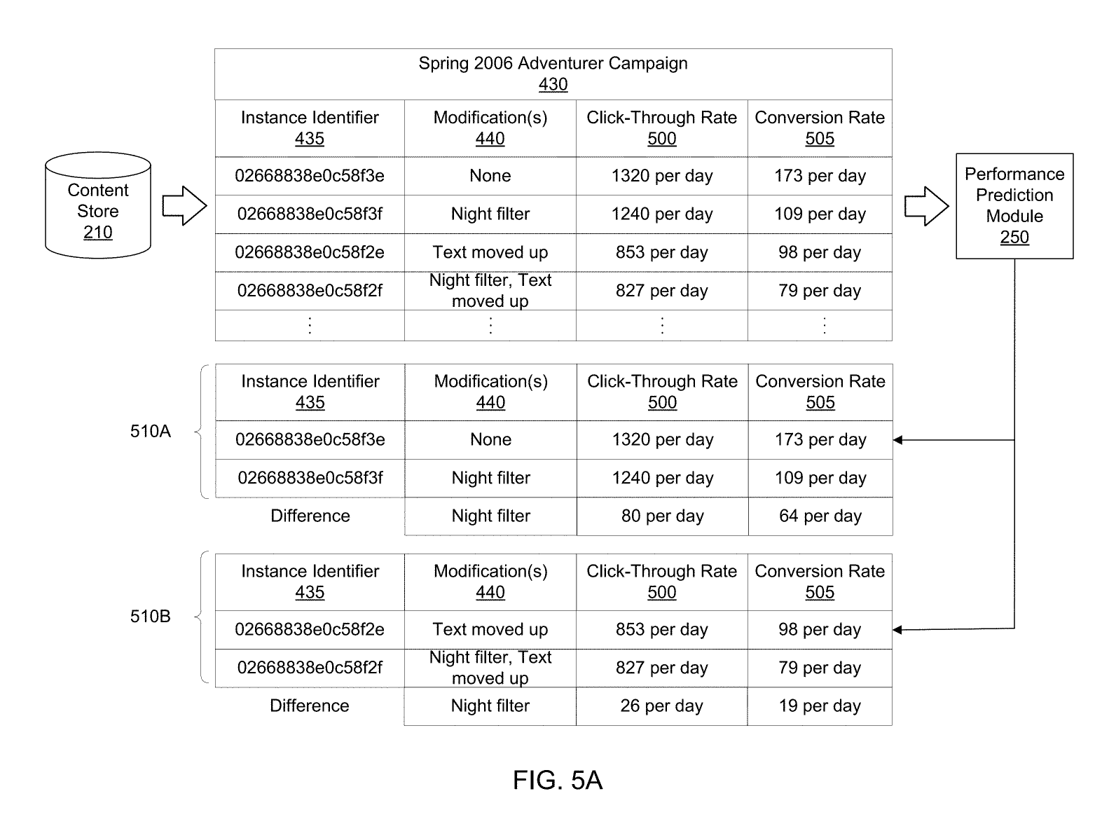

In embodiments in which identifiers used to identify instances of a content item have a measure of similarity that is proportional to the degree to which their content was modified, the content identification module 245 may identify different instances of a content item based on similarities between their associated identifiers. For example, if there are two instances of a content item and an image hash associated with an instance of the content item is stored in the content store 210, the content identification module 245 may identify the other instance of the content item if it is associated with an image hash that is different from the stored image hash, but has at least a threshold measure of similarity to the stored image hash. Furthermore, in some embodiments, multiple instances of a content item may be identified with the same identifier. For example, since images that are very similar (e.g., the same image saved using different formats or resolutions or containing minor corruptions) may hash to the same image hash, instances of a content item including very similar images may be identified with the same identifier. The content identification module 245 is further described below in conjunction with FIGS. 3 and 4.

The performance prediction module 250 compares values of one or more performance metrics associated with different instances of a content item to each other. The values of a performance metric may be compared and the comparison repeated for each additional performance metric. The performance prediction module 250 may use A/B testing or any other suitable method of comparison to compare the values of the performance metric(s) between instances. For example, the performance prediction module 250 may identify different pairs of instances of a content item, in which the instances of each pair differ only in one aspect (e.g., font color or placement of text included in their content), and use A/B testing to compare the number of comments on the instances of each pair. In some embodiments, the performance prediction module 250 compares the values of a performance metric associated with instances of a content item, in which the instances differ only in one aspect, and ranks the instances based on the values. For example, if each instance of an advertisement for a mobile device features an image of the device in a different color (e.g., black, white, silver, and gold), the performance prediction module 250 ranks the instances of the advertisement based on their associated conversion rates.

The performance prediction module 250 also determines differences between values of one or more performance metrics associated with different instances of a content item. In embodiments in which the performance prediction module 250 compares values of a performance metric associated with instances of a content item using A/B testing, the performance prediction module 250 determines a difference between the values of the performance metrics associated with a pair of content item instances based on the comparison of their values. In embodiments in which the performance prediction module 250 compares values of a performance metric associated with instances of a content item and then ranks the instances based on their values, the performance prediction module 250 may determine the differences between the values as an amount of variation in the values. For example, the performance prediction module 250 determines a standard deviation or variance in the values of a performance metric associated with instances of a content item.

The performance prediction module 250 identifies a subset of modifications to the appearance of content included in different instances of a content item to which differences/variation in values of performance metrics associated with the instances may be attributable, wherein the modifications were specified by a content-providing user of the online system who requested to generate the content item. In embodiments in which the performance prediction module 250 compares values of one or more performance metrics associated with different instances of a content item to each other using A/B testing, the performance prediction module 250 identifies an aspect in which the instances of the content item of each pair of instances differ and attributes the difference in the values of the performance metrics to that aspect. For example, if the only difference between a pair of instances of a content item is that one instance includes a cropped version of an image and the other instance includes an uncropped version of the image, the performance prediction module 250 attributes a difference in the values of a performance metric associated with the instances to the cropping. In embodiments in which the performance prediction module 250 ranks instances of a content item based on the value of a performance metric associated with each instance, the performance prediction module 250 identifies the aspect in which the instances of the content item of the ranking differ and attributes an amount of variation in the values of the performance metrics to that aspect. For example, if the only difference between five instances of an advertisement for a pen is that each instance includes an image of the pen with different colored ink, the performance prediction module 250 attributes an amount of variation in the values of a performance metric associated with the instances to the ink color of the pen in the image included in each instance.

In some embodiments, the performance prediction module 250 only attributes a difference between values/an amount of variation among values of a performance metric to a modification to content included in instances of a content item if the difference/amount of variation is at least a threshold difference/amount of variation. For example, if the difference between the rates at which different instances of a content item are shared is at least a threshold rate, the performance prediction module 250 attributes the difference between the rates to a modification responsible for the aspect in which the instances differ. As an additional example, if a variance in a number of times that viewing users of the online system 140 expressed a preference for four different instances of a content item is less than a threshold variance, in which each instance includes the same text in a different color, the performance prediction module 250 does not attribute the variance to the different font colors.

The performance prediction module 250 predicts the effect of a set of modifications to the appearance of content included in a content item on the performance of instances of the content item including the set of modifications. The prediction may include improvements in values of a performance metric of the instances and/or diminishment in the values of the performance metric. For example, the performance prediction module 250 may predict that when compared to the number of users who are likely to share a content item absent application of any filters to content included in the content item, application of a particular filter will increase the number of users who share the content item, while application of a different filter will decrease the number of users who share the content item.

The performance prediction module 250 may predict the effect of a set of modifications to content included in a content item on the performance of instances of the content item including the modifications based on the difference/variation in values of one or more performance metrics associated with different instances of the content item. For example, if the performances of two different instances of a content item are compared, in which text is placed at the top of one instance and the same text is placed at the bottom of the other instance, and the former has a 10% higher click-through rate than the latter, the performance prediction module 250 may predict a 10% higher click-through rate for instances of the content item in which the text is placed at the top than for instances in which the text is placed at the bottom. In one embodiment, the prediction is based on a correlation between the set of modifications to the content included in different instances of the content item and the difference/amount of variation in the performances of the different instances of the content item. For example, if the performance prediction module 250 ranks multiple instances of a content item including an image of a t-shirt based on the rates at which the instances were shared, the performance prediction module 250 predicts that modifying the color of the t-shirt to that of the highest ranked instance will improve the rate at which the content item will be shared.

The prediction may be expressed at various levels of granularity of modification to content included in a content item. For example, the performance prediction module 250 may predict the cumulative effect of multiple modifications made to content included in a content item (e.g., the effect of multiple filters applied to a photograph using a filter feature). Alternatively, the performance prediction module 250 may predict the effect of each individual filter that may be applied to the photograph.

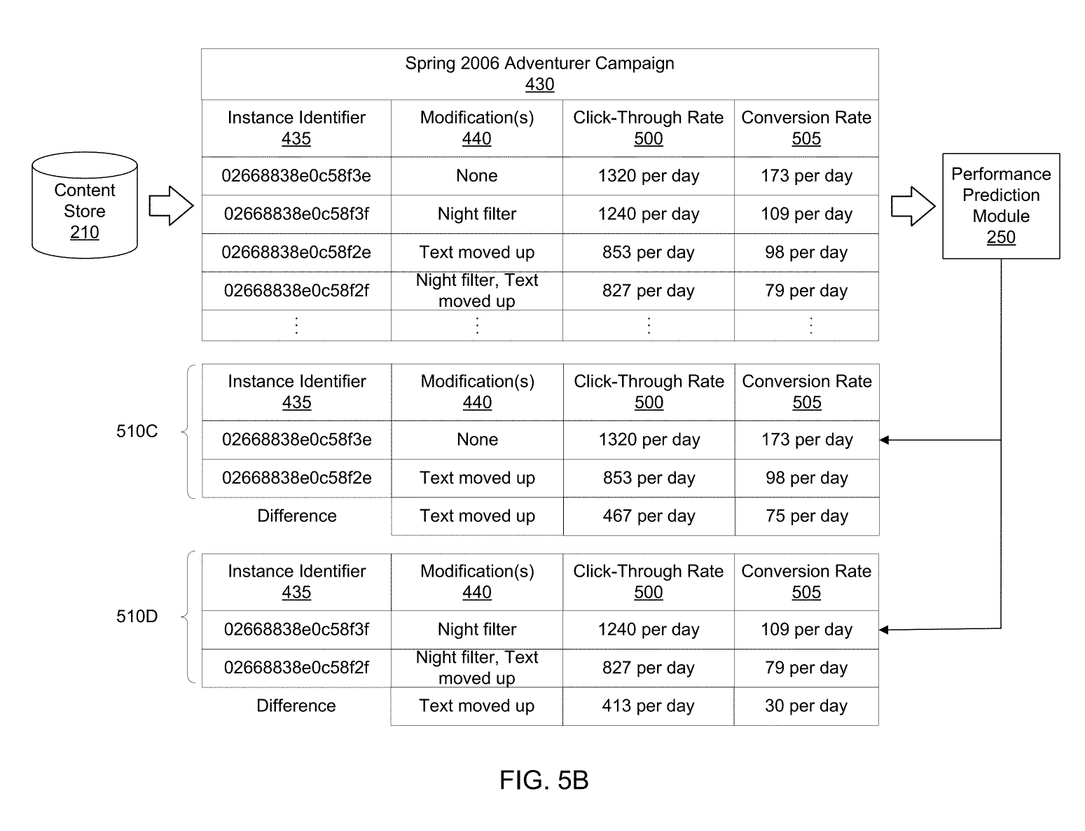

In some embodiments, the performance prediction module 250 also may predict the effect of modifications to content included in a content item on the performance of instances of the content item including the modifications using a machine-learned model, as such models are known in the art. For example, the performance prediction module 250 may predict that instances of a content item that include content to which a particular filter is applied will result in an 8% increase in conversion rates over instances in which the filter is not applied based on conversion rates for instances of content items including similar content to which the filter was and was not applied. The performance prediction module 250 is further described below in conjunction with FIGS. 3, 5A, and 5B.

The web server 255 links the online system 140 via the network 120 to the one or more client devices 110, as well as to the third party system 130 and/or one or more third party systems. The web server 255 serves web pages, as well as other content, such as JAVA®, FLASH®, XML and so forth. The web server 255 may receive and route messages between the online system 140 and the client device 110, for example, instant messages, queued messages (e.g., email), text messages, short message service (SMS) messages, or messages sent using any other suitable messaging technique. A user may send a request to the web server 255 to upload information (e.g., images or videos) that are stored in the content store 210. Additionally, the web server 255 may provide application programming interface (API) functionality to send data directly to native client device operating systems, such as IOS®, ANDROID™, WEBOS® or BlackberryOS.

### Predicting the Effect of Modifications to Content Included in a Content Item

FIG. 3 is a flow chart of a method for predicting the effect of one or more modifications to an appearance of content included in instances of a content item on a performance metric associated with the content item, according to one embodiment. In other embodiments, the method may include different and/or additional steps than those shown in FIG. 3. Additionally, steps of the method may be performed in a different order than the order described in conjunction with FIG. 3.

The online system 140 may receive 305 content (e.g., images) for including in one or more content items to be presented to one or more viewing users of the online system 140. The content may be received 305 by the content item generator 235 via a tool provided by the online system 140 that enables content-providing users of the online system 140 to upload content and/or specify content previously received by the online system 140 to be included in content items. For example, the content item generator 235 receives 305 multiple photographs from a content-providing user of the online system 140 that uploaded the photographs using the tool. Content-providing users may interact with the tool via a user interface generated and presented to the content-providing users by the user interface module 240. For example, a content-providing user may interact with the tool via a window or page generated and presented by the user interface module 240 in a display area of a client device 110 that allows the content-providing user to browse their client device 110 for photographs and other types of content to upload to the online system 140. Content uploaded by content-providing users may be stored in the content store 210 in association with information identifying the content-providing user that uploaded the content (e.g., username or user identification number) and information describing the content (e.g., filename, size, format, date uploaded, etc.).

The online system 140 receives 310 a request from a content-providing user of the online system 140 to generate a content item including the received content. Similar to the content provided by the content-providing users, the request may be received 310 by the content item generator 235 via the user interface for the tool provided by the online system 140 that enables the content-providing user to submit a request to generate a content item (e.g., an advertisement) that may include content received from the content-providing user. For example, the content-providing user may interact with a window or page presented by the user interface module 240 in a display area of a client device 110, through which the content-providing user may select content previously uploaded to the online system 140 by the content-providing user and submit a request to generate a content item including the selected content (e.g., via buttons, drop-down menus, etc.). As an additional example, the content item generator 235 receives 310 a request from a user to generate a content item including a photograph and text describing the photograph, in which the photograph and the text were provided by the content-providing user using the tool. In some embodiments, the online system 140 receives 305 the content for including in the content item at the same time it receives 310 the request to generate the content item (e.g., via the user interface for the tool provided by the online system 140).

The request received 310 by the online system 140 may include one or more modifications to the appearance of the content to be included in the content item specified by the content-providing user. The content-providing user may specify the modifications to the appearance of the content using the user interface by interacting with options that may be included in the user interface that correspond to various features of the tool provided by the online system 140 that enable the content-providing user to modify an appearance of the content. For example, features of the tool (e.g., filters, fonts, etc.) correspond to tabs in the user interface and sub-features (e.g., filter types, font types, etc.) correspond to buttons within each tab that may be selected by the content-providing user and used to modify the appearance of content to be included in the content item. Examples of features of the tool include features that allow the content-providing user to crop the content to be included in the content item, change the size, color, or placement of text or other elements included in the content, or perform any other suitable modification to the appearance of the content. For example, the content-providing user may crop a photograph with a cropping feature and alter colors in the photograph with a color feature (e.g., change the hue, brightness or saturation of colors of the photograph). As an additional example, features of the tool may allow the content-providing user to modify an image of a watch, such that the content-providing user may change the color of the watchband from white to blue and blur out elements of the image other than the watch.

The content item generator 235 generates 315 a plurality of instances of the content item, in which each instance includes a different set of the modifications specified in the request received from the content-providing user. For example, the content item generator 235 may generate 315 two instances of an advertisement for a classic car requested by an advertiser, in which one instance includes an original photograph of the car while the other instance includes the same photograph of the car that was modified using a vintage filter that makes the photograph appear to have been aged. The instances of the content item may include one or more interactive elements that allow viewing users of the instances to perform actions associated with the instances (e.g., a “like” button, a “comment” button, a “share” button, etc.). For example, an instance of an advertisement for a product or service may include a “buy now” button that allows viewing users who click on the button to be redirected to a third party website where they may purchase the product or service.

In some embodiments, if the content-providing user uses a feature of the tool to modify content that is included in the content item, the content item generator 235 may generate 315 an instance of the content item including the requested modification and also automatically generate 315 an additional instance of the content item that includes the content absent the modification (i.e., a control instance of the content item). For example, if an advertisement includes an image that was pixelated at the request of an advertiser, the content item generator 235 may automatically generate 315 another instance of the advertisement that includes the original unpixelated image. In this example, if the pixelated image was subsequently filtered using a filter feature of the tool, the content item generator 235 also may automatically generate 315 an instance of the advertisement that includes the pixelated unfiltered image and another instance of the advertisement that includes the unpixelated filtered image. As an additional example, if a content item includes content with text and a feature of the tool is used to change the color of the text from gray to white, the content item generator 235 may generate 315 an instance of the content that includes the white text and automatically generate another instance of the content item that includes the original gray text.

In the example of FIG. 4, four instances 400A-D of an advertisement for a car differ based on modifications made to a photograph of the car included in the advertisement. The original photograph of the car was taken in the daytime 405A and includes the text 410A at the bottom of the photograph. One modification to the photograph involves application of a filter to the photograph that makes the photograph appear to have been taken at night 405B. Another modification to the photograph involves changing the placement of text 410A-B in the photograph (from the bottom to the top of the photograph). The four instances 400A-D of the advertisement include the different possible combinations of the modifications that may be made to the photograph; the first instance 400A includes the photograph of the car in the day 405A with the text 410A at the bottom, the second instance 400B includes the photograph of the car at night 405B with the text 410A at the bottom, the third instance 400C includes the photograph of the car in the day 405A with the text 410B at the top, and the fourth instance 400D includes the photograph of the car at night 405B with the text 410B at the top. In some embodiments, the fourth instance 400D is generated 315 based on the request to generate the content item received 310 from the content-providing user and the modifications specified in the request while the other instances are generated 315 automatically by the content item generator 235 as control instances of the content item.

Referring back to FIG. 3, the content identification module 245 generates 320 an identifier associated with each instance of the content item based on modifications to an appearance of content included in the instances. The content identification module 245 may use various techniques to generate 320 identifiers that allow each set of modifications to the appearance of the content, and hence, each instance of the content item including a set of modifications to the appearance of the content, to be uniquely identified. Examples of such techniques include using an image fingerprint, an image hash, a digital watermark, or any other suitable identifier. For example, the content identification module 245 embeds a digital watermark into an image included in an instance of a content item, in which the digital watermark includes an identification number or other information that allows the instance to be uniquely identified based on an absence of any modifications to the appearance of the image. In this example, if another instance of the content item includes a filtered version of the image, the content identification module 245 may embed a different digital watermark into the cropped image that uniquely identifies the instance based on the filtering of the original image.

In some embodiments, identifiers used to identify instances of a content item based on modifications to an appearance of their content may have a measure of similarity to each other that is proportional to the degree to which their content was modified. For example, the content identification module 245 may apply a hash function to two different versions of an image (e.g., an original image and a modified image) included in different instances of a content item and compute an image hash for each version based on the image's visual appearance (e.g., based on differences between adjacent pixel values). In this example, the degree of similarity between the image hashes is proportional to the degree of similarity between the appearances of the versions of the image.

The content identification module 245 may store 325 the identifiers used to identify instances of the content item in association with information describing modifications to the appearance of the content to which they are associated and/or in association with the instances of the content item including the modifications to the appearance of their content (e.g., in the content store 210). For example, as shown in FIG. 4, an identifier 435 associated with each instance 400A-D of the advertisement may be generated 320A-D by the content identification module 245 and stored 325 in a table specific to an advertisement campaign 430 that includes information describing the modifications made to the photograph 440. In this example, the table may be stored 325 within the content store 210 in association with additional types of information associated with each instance (e.g., values of one or more performance metrics).

Referring again to FIG. 3, the user interface module 240 presents 330 the content item instances to one or more viewing users of the online system 140. Instances of a content item may be presented 330 on client devices 110 associated with viewing users in a feed, in a pop-up window, or any other suitable method for presenting content. For example, an instance of the content item may be presented to a viewing user in a newsfeed associated with a profile of the viewing user in conjunction with additional content items and advertisements. Instances of the content item may be presented 330 to similar groups of viewing users. For example, each instance of the content item is presented 330 to viewing users having at least a threshold measure of similarity to each other (e.g., viewing users who satisfy the same targeting criteria). In some embodiments, only one instance of each content item is presented 330 to a viewing user of the online system 140, while in other embodiments, multiple instances of a content item may be presented 330 to the same viewing user.

The content identification module 245 tracks 335 one or more performance metrics associated with each instance of the content item using the identifier associated with each instance. For example, the content identification module 245 receives data about click-through rates for instances of the content item during a specified period of time and identifies data about each instance of the content item based on digital watermarks associated with the data that match the digital watermark associated with each instance. In some embodiments, the content identification module 245 uses the same technique used to generate the identifier for an instance of a content item to identify performance metrics associated with the instance of the content item. For example, when the content identification module 245 receives information describing a conversion resulting from an interaction from a viewing user with an instance of a content item, the content identification module 245 applies the same hash function used to generate an identifier for the instance to the content included in the instance to determine the identifier for the instance. In this example, the content identification module 245 may then identify the instance with which the viewing user interacted based on its identifier (e.g., by retrieving information associated with a matching identifier from the content store 210). Alternatively, the content identification module 245 may retrieve information stored in a digital watermark embedded in the content included in the instance and identify the instance based on the information.

In embodiments in which identifiers used to identify instances of a content item have a measure of similarity that is proportional to the degree to which their content was modified, the content identification module 245 may identify different instances of a content item based on similarities between their associated identifiers. For example, if there are two instances of a content item and an image hash associated with an instance of the content item is stored in the content store 210, the content identification module 245 may identify the other instance of the content item if it is associated with an image hash that is different from the stored image hash, but has at least a threshold measure of similarity to the stored image hash. Furthermore, in some embodiments, multiple instances of a content item may be identified with the same identifier. For example, since images that are very similar (e.g., the same image saved using different formats or resolutions, or containing minor corruptions) may hash to the same image hash, instances of a content item including very similar images may be identified with the same identifier.

The content identification module 245 may store 340 the data it tracks describing the one or more performance metrics associated with each instance of the content item. In the example of FIG. 5A, the content identification module 245 stores 340 information about the click-through rate 500 and conversion rate 505 for each instance 400A-D of the advertisement in FIG. 4 in a table associated with the advertisement campaign 430 (e.g., in the content store 210). In addition to the information describing values of one or more performance metrics (e.g., click- through rate 500 and conversion rate 505), information in the table describing each instance 400A-D may include an image hash or other type of identifier 435 associated with the instance 400A-D, and a description of any modifications 440 to the content included in the instance 400A-D.

Referring back to FIG. 3, the performance prediction module 250 identifies 345 one or more pairs of the plurality of content item instances and for each pair of content item instances, the performance prediction module 250 compares 350 values of a performance metric associated with instances of the pair to each other. After an evaluation period has elapsed, during which information describing the performance of each instance of the content item has been tracked 335, the performance prediction module 250 may identify 345 different combinations of pairs of instances of the content item. For example, the performance prediction module 250 may identify 345 pairs of instances of a content item, in which the instances of each pair differ only in one aspect (e.g., font color or placement of text included in their content). In some embodiments, values of more than one performance metric are compared 350 for each pair of instances, such that the values of a performance metric may be compared 350 and the comparison repeated for each additional performance metric. The performance prediction module 250 may use A/B testing or any other suitable method of comparison to compare 350 the values of the performance metric(s) between instances.

In the example of FIG. 5A, the performance prediction module 250 uses A/B testing to compare 350 the click-through rate 500 and conversion rate 505 between instances in two different pairs 510A-B of instances 400A-D of the advertisement for the car, in which each pair 510A-B differs in only a single aspect. The first instance 400A, 400C in each pair 510A-B (i.e., the first and third instances 400A, 400C in FIG. 4) includes the photograph of the car absent application of the filter, while the second instance 400B, 400D in each pair 510A-B (i.e., the second and fourth instances 400B, 400D in FIG. 4) includes the photograph of the car that appears to have been taken at night 405B as a result of application of the filter. In some embodiments, the performance prediction module 250 compares 350 the values of each performance metric associated with each instance of a content item, in which the instances differ only in one aspect, and ranks the instances based on their relative values. For example, if there are four instances of an advertisement for a mobile device and each instance of the advertisement features an image of the device in a different color (e.g., black, white, silver, and gold), the performance prediction module 250 ranks the instances of the advertisement based on their associated conversion rates.

Referring again to FIG. 3, the performance prediction module 250 determines 355 a difference between the values associated with instances of the pair of content item instances. If the performance prediction module 250 compares 350 values of a performance metric associated with a pair of instances of a content item using A/B testing, the performance prediction module 250 determines 355 a difference between the values of the performance metrics associated with the pair of instances based on the comparison. For example, as shown in FIG. 5A, based on the comparison of the click-through rate 500 and conversion rate 505 for each pair 510A-B of instances 400A-D of the advertisement, the performance prediction module 250 determines 355 that for the first pair 510A of instances 400A-B of the advertisement, a difference between the click-through rates 500 for the instances 400A-B is 80 clicks per day and a difference between the conversion rates 505 for the instances 400A-B is 64 conversions per day. Additionally, the performance prediction module 250 determines 355 that for the second pair 510B of instances 400C-D of the advertisement, a difference between the click-through rates 500 for the instances 400C-D is 26 clicks per day and a difference between the conversion rates 505 for the instances 400C-D is 19 conversions per day. In embodiments in which the performance prediction module 250 compares 350 values of a performance metric associated with instances of a content item and ranks the instances based on their relative values, the performance prediction module 250 may determine 350 the differences between the values by computing an amount of variation in the values. For example, the performance prediction module 250 determines 350 the differences by computing a standard deviation or variance in the values of a performance metric associated with instances of a content item.

Referring once more to FIG. 3, the performance prediction module 250 identifies 360 a subset of modifications specified in the request to which the difference between the values associated with the instances of the pair is attributable. In embodiments in which the performance prediction module 250 compares 350 the values of the performance metric associated with the instances of the content items of the pair to each other using A/B testing, the performance prediction module 250 identifies 360 the aspect in which the instances of the content item of the pair differ and attributes the difference in the values of the performance metrics to that aspect. For example, if the only difference between the pair of instances of the content item is that one instance includes a filtered version of an image and the other instance includes an unfiltered version of the image, the performance prediction module 250 attributes a difference in the values of a performance metric associated with the instances to application of the filter. As an additional example, since the only difference between the instances 400A-D in each pair 510A-B of instances 400A-D of the advertisement in FIG. 5A is the application of the filter to the photograph that made the photograph in the second instances 400B, 400D of the pairs 510A-B appear to have been taken at night 405B, the performance prediction module 250 attributes differences between the click-through rates 500 and conversion rates 505 for the instances 400A-D to application of the filter.

In embodiments in which the performance prediction module 250 ranks instances of a content item based on the relative values of a performance metric associated with each instance, the performance prediction module 250 identifies 360 the aspect in which the instances of the content item of the ranking differ and attributes an amount of variation in the values of the performance metrics to that aspect. For example, if the only difference between three instances of an advertisement for camping equipment is that each instance includes an image of the equipment during a different time of day, the performance prediction module 250 attributes an amount of variation in the values of the performance metric associated with the instances to the different time of day depicted in the image included in each instance.

In some embodiments, the performance prediction module 250 only attributes a difference between values/an amount of variation among values of the performance metric to a modification to content included in instances of the content item if the difference/amount of variation is at least a threshold difference/amount of variation. For example, if the difference between the click-through rates for the pair of instances of the content item is at least a threshold rate, the performance prediction module 250 attributes the difference between the click-through rates to a modification responsible for the aspect in which the instances of the pair differ. As an additional example, if the standard deviation for the number of times viewing users of the online system 140 expressed a preference for three different instances of a content item that include the same text in different types of font is less than a threshold standard deviation, the performance prediction module 250 does not attribute the standard deviation to the different font types.

As shown in FIG. 3, the performance prediction module 250 predicts 365 an improvement in a value of the performance metric associated with content item instances including the identified set of modifications. The performance prediction module 250 predicts 365 the improvement based at least in part on the difference between the values associated with the pair of instances. For example, the performance prediction module 250 may predict 365 that when compared to the number of users who are likely to share a content item absent application of any filters to content included in the content item, application of a particular filter will increase the number of users who share the content item. In some embodiments, the performance prediction module 250 also may predict 365 a diminishment in the value of the performance metric associated with content item instances including the identified set of modifications. In this example, the performance prediction module 250 may predict 365 that application of a different filter will decrease the number of users who share the content item.

In one embodiment, the prediction 365 is based on a correlation between the set of modifications to the content included in different instances of the content item and the comparison of the performances of the different instances of the content item. For example, as shown in FIG. 5A, the instance 400A of the advertisement including the photograph of the car taken in the day achieved 80 more clicks per day than the instance 400B including the filtered photograph for the first pair 510A of instances 400A-B of the advertisement and 26 more clicks per day for the second pair 510B of instances 400C-D. Therefore, the performance prediction module 250 predicts 365 that instances 400A, 400C of the advertisement including a photograph of the car taken in the day will likely achieve 53 more clicks per day than instances 400B, 400D of the advertisement including the filtered photograph based on the average of the differences. As an additional example, the instance 400A of the advertisement including the photograph of the car taken in the day achieved 64 more conversions per day than the instance 400B including the filtered photograph for the first pair 510A of instances 400A-B of the advertisement and 19 more conversions per day for the second pair 510B of instances 400C-D. Therefore, the performance prediction module 250 predicts 365 that instances 400A, 400C of the advertisement including a photograph of the car taken in the day will likely achieve 42 more conversions per day than instances 400B, 400D of the advertisement including the filtered photograph based on the average of the differences.

As shown in FIG. 5B, the performance prediction module 250 may repeat the entire process with different pairs 510C-D of instances 400A-D of the advertisement. For example, the performance prediction module 250 uses A/B testing to compare 350 the click-through rate 500 and conversion rate 505 between instances 400A-D in two different pairs 510C-D of instances 400A-D of the advertisement for the car. Here, the first instance 400A-B in each pair 510C-D (i.e., the first and second instances 400A, 400B in FIG. 4) includes the photograph of the car with the text 410A at the bottom of the content and the second instance 400C-D in each pair 510C-D (i.e., the third and fourth instances 400C-D in FIG. 4) includes the photograph of the car with the text 410B at the top of the content.

The performance prediction module 250 may then perform a similar analysis as described above in conjunction with FIG. 5A and predict 365 an improvement in a value of the performance metrics associated with content item instances including a set of modifications to the appearance of the content included in the instances to which the difference between the values is attributable. For example, the instance 400A of the advertisement including the photograph of the car with the text 410A at the bottom achieved 467 more clicks per day than the instance 400C including the text 410B at the top for the first pair 510C of instances 400A, 400C of the advertisement and 413 more clicks per day for the second pair 510D of instances 400B, 400D. Therefore, the performance prediction module 250 predicts 365 that instances 400A-B of the advertisement including a photograph of the car with text 410A at the bottom will likely achieve 440 more clicks per day than instances 400C-D of the advertisement including the text 410B at the top based on the average of the differences. As an additional example, the instance 400B of the advertisement including the filtered photograph of the car with the text 410A at the bottom achieved 75 more conversions per day than the instance including the filtered photograph with the text 410B at the top for the first pair 510C of instances 400A, 400C of the advertisement and 30 more conversions per day for the second pair 510D of instances 400B, 400D. Therefore, the performance prediction module 250 predicts 365 that instances 400A-B of the advertisement including the text 410A at the bottom will likely achieve 53 more conversions per day than instances 400C-D of the advertisement including the text 410B at the top based on the average of the differences.

The performance prediction module 250 may predict 365 the effect of multiple modifications to the appearance of the content included in the instances of the content item to which the difference between the values is attributable. For example, based on the averages of the improvements in the click-through rate 500 determined by the performance prediction module 250 in FIGS. 5A and 5B, the performance prediction module 250 predicts 365 that instances of the content item that include the photograph of the car taken in the day 405A with the text 410A at the bottom will likely achieve 247 more clicks per day than instances of the content item that include the filtered photograph of the car with the text 410B at the top based on the average of the predicted improvement in the click-through rates 500((53+440)/2=246.5). Similarly, based on the averages of the improvements in the conversion rate 505 determined by the performance prediction module 250 in FIGS. 5A and 5B, the performance prediction module 250 predicts 365 that instances of the content item that include the photograph of the car taken in the day 405A with the text 410A at the bottom will likely achieve 48 more conversions per day than instances 400A-D of the content item that include the filtered photograph of the car with the text 410B at the top based on the average of the predicted improvement in the conversion rates 505((42+53)/2=47.5).

Referring back to FIG. 3, in another embodiment, the prediction 365 is based on a correlation between the set of modifications to the content included in different instances of the content item and an amount of variation in the performances of the different instances of the content item. For example, if the performance prediction module 250 ranks multiple instances of a content item based on the rate at which the instances were shared, in which each instance includes an image of a different colored bicycle, the performance prediction module 250 predicts 365 that modifying the color of the bicycle to that of the highest ranked instance will improve the rate at which the content item will be shared. The prediction 365 may describe the set of modifications at various levels of granularity. For example, the performance prediction module 250 may predict 365 the cumulative effect of multiple modifications made to content included in a content item (e.g., the effect of multiple filters applied to a photograph using a filter feature). Alternatively, the performance prediction module 250 may predict 365 the effect of each filter applied to the photograph. In some embodiments, the performance prediction module 250 also may make the prediction 365 using a machine-learned model. For example, the performance prediction module 250 may predict 365 that instances of a content item that include cropped content will result in an 8% increase in conversion rates over instances in which the content is not cropped based on conversion rates for instances of content items including similar content that was both cropped and not cropped.

The predicted improvement may be communicated 370 to the content-providing user that requested to generate the content item to help the content-providing user improve the quality of their content item. The prediction 365 may be communicated 360 to the content-providing user via the user interface through which the content-providing user requested to generate the content item. For example, after period of time during which the performance of each instance of the content item has been evaluated, the user interface module 240 presents the prediction 365 in the user interface to the content-providing user that requested to generate the content item (e.g., via a pop-up window). In some embodiments, the online system 140 may communicate 370 the predicted effect as a suggestion that the content-providing user incorporate particular modifications to the content in the content items and provide an explanation of the likely impact on one or more performance metrics corresponding to the suggested modifications. For example, information presented in the user interface may inform a content-providing user that requested to generate multiple instances of a content item that adoption of only the instance of the content item that achieved the best performance metric value will likely result in a 7% predicted increase in the rate at which viewing users will express a preference for the content item over the other instances of the content item. Additionally, information presented in the user interface may suggest that the content-providing user use certain features of the tool to modify the content in the content items based on the predicted effect of modifications made using the features and provide previews of instances of the content item that include content that has been modified with the features. For example, the online system 140 may suggest that the content-providing user use a filter feature of the tool to apply a filter to a photograph to be included in a content item and provide a preview of the content item after applying the filter to the photograph.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, in which the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a request from a content-providing user of an online system to generate a content item to be presented to one or more viewing users of the online system, the request specifying one or more modifications to an appearance of content received from the content-providing user;
generating a plurality of content item instances of the content item, each of the plurality of content item instances including a different set of the one or more modifications to the appearance of the content specified in the request;
generating an identifier for each of the plurality of content item instances, each identifier associated with the set of the one or more modifications to the appearance of the content included in the content item instance;
presenting the plurality of content item instances to a subset of the one or more viewing users of the online system;
tracking a performance metric associated with impressions of each of the plurality of content item instances using the identifier associated with the set of the one or more modifications to the appearance of the content included in each of the plurality of content item instances;
identifying one or more pairs of the plurality of content item instances; and
for each of the one or more pairs of the plurality of content item instances:
comparing a first value of the performance metric associated with a first content item instance of the pair to a second value of the performance metric associated with a second content item instance of the pair;
determining a difference between the first value of the performance metric associated with the first content item instance and the second value of the performance metric associated with the second content item instance based at least in part on the comparing;
identifying a subset of the one or more modifications to the appearance of the content to which the difference between the first value of the performance metric associated with the first content item instance and the second value of the performance metric associated with the second content item instance is attributable; and
predicting an improvement in a value of the performance metric associated with content item instances including the subset of the one or more modifications, based at least in part on the difference between the first value of the performance metric associated with the first content item instance and the second value of the performance metric associated with the second content item instance.

2. The method of claim 1, wherein the identifier associated with the set of the one or more modifications to the appearance of the content included in each of the plurality of content item instances comprises a digital watermark, an image fingerprint, or an image hash.

3. The method of claim 1, wherein the one or more modifications to the appearance of the content are selected from a group consisting of: modifying one or more colors of the content, modifying a placement of an element of the content, modifying a size of the content, modifying a size of an element of the content, modifying a color of an element of the content, and any combination thereof.

4. The method of claim 1, wherein the improvement in the value of the performance metric associated with content item instances including the subset of the one or more modifications is predicted by a machine-learned model.

5. The method of claim 1, wherein the request is received from the content-providing user via a tool provided by the online system.

6. The method of claim 5, wherein the one or more modifications are specified using one or more features of the tool.

7. The method of claim 6, further comprising:
identifying a feature of the tool used to specify the subset of the one or more modifications to the appearance of the content to which the difference between the first value of the performance metric associated with the first content item instance and the second value of the performance metric associated with the second content item instance is attributable; and
predicting the improvement in the value of the performance metric associated with content item instances including the subset of the one or more modifications based at least in part on the difference between the first value of the performance metric associated with the first content item instance and the second value of the performance metric associated with the second content item instance.

8. The method of claim 1, wherein the content comprises one or more selected from a group consisting of: an image, a photograph, text, and any combination thereof.

9. The method of claim 1, wherein the performance metric describes a number of times a content item instance is accessed, a number of times a preference for the content item instance is indicated, a number of installations of an application associated with the content item instance, a number of times an application associated with the content item instance is accessed, a number of purchases of a product associated with the content item instance, a number of purchases of a service associated with the content item instance, a number of views of data associated with the content item instance, a number of conversions associated with the content item instance, a number of subscriptions associated with the content item instance, or a number of interactions with the content item instance.

10. The method of claim 1, further comprising:
ranking the plurality of content item instances based at least in part on the value of the performance metric associated with each content item instance of the plurality of content item instances;
determining an amount of variation in values of the performance metric associated with the plurality of content item instances;
responsive to determining the amount of variation in values of the performance metric associated with the plurality of content item instances is at least a threshold amount, identifying an additional subset of the one or more modifications to the appearance of the content to which the amount of variation in values of the performance metric associated with the plurality of content item instances is attributable; and
predicting the improvement in the value of the performance metric associated with content item instances including the additional subset of the one or more modifications based at least in part on the ranking and the amount of variation in values of the performance metric associated with the plurality of content item instances.

11. The method of claim 1, further comprising:
storing the identifier associated with the set of the one or more modifications to the appearance of the content included in each of the plurality of content item instances in association with each of the plurality of content item instances including the set of the one or more modifications to the appearance of the content.

12. The method of claim 1, further comprising:
communicating the predicted improvement in the value of the performance metric associated with content item instances including the subset of the one or more modifications to the content-providing user of the online system.

13. The method of claim 1, further comprising:
receiving the content from the content-providing user of the online system.

14. A computer program product comprising a computer readable storage medium having instructions encoded thereon that, when executed by a processor, cause the processor to:
receive a request from a content-providing user of an online system to generate a content item to be presented to one or more viewing users of the online system, the request specifying one or more modifications to an appearance of content received from the content-providing user;
generate a plurality of content item instances of the content item, each of the plurality of content item instances including a different set of the one or more modifications to the appearance of the content specified in the request;
generate an identifier for each of the plurality of content item instances, each identifier associated with the set of the one or more modifications to the appearance of the content included in the content item instance;
present the plurality of content item instances to a subset of the one or more viewing users of the online system;
track a performance metric associated with impressions of each of the plurality of content item instances using the identifier associated with the set of the one or more modifications to the appearance of the content included in each of the plurality of content item instances;
identify one or more pairs of the plurality of content item instances; and
for each of the one or more pairs of the plurality of content item instances:
compare a first value of the performance metric associated with a first content item instance of the pair to a second value of the performance metric associated with a second content item instance of the pair;
determine a difference between the first value of the performance metric associated with the first content item instance and the second value of the performance metric associated with the second content item instance based at least in part on the comparing;
identify a subset of the one or more modifications to the appearance of the content to which the difference between the first value of the performance metric associated with the first content item instance and the second value of the performance metric associated with the second content item instance is attributable; and
predict an improvement in a value of the performance metric associated with content item instances including the subset of the one or more modifications, based at least in part on the difference between the first value of the performance metric associated with the first content item instance and the second value of the performance metric associated with the second content item instance.

15. The computer program product of claim 14, wherein the identifier associated with the set of the one or more modifications to the appearance of the content included in each of the plurality of content item instances comprises a digital watermark, an image fingerprint, or an image hash.

16. The computer program product of claim 14, wherein the one or more modifications to the appearance of the content are selected from a group consisting of:
modifying one or more colors of the content, modifying a placement of an element of the content, modifying a size of the content, modifying a size of an element of the content, modifying a color of an element of the content, and any combination thereof.

17. The computer program product of claim 14, wherein the improvement in the value of the performance metric associated with content item instances including the subset of the one or more modifications is predicted by a machine-learned model.

18. The computer program product of claim 14, wherein the request is received from the content-providing user via a tool provided by the online system.

19. The computer program product of claim 18, wherein the one or more modifications are specified using one or more features of the tool.

20. The computer program product of claim 18, wherein the computer readable storage medium further has instructions encoded thereon that, when executed by the processor, cause the processor to:
identifying a feature of the tool used to specify the subset of the one or more modifications to the appearance of the content to which the difference between the first value of the performance metric associated with the first content item instance and the second value of the performance metric associated with the second content item instance is attributable; and
predicting the improvement in the value of the performance metric associated with content item instances including the subset of the one or more modifications based at least in part on the difference between the first value of the performance metric associated with the first content item instance and the second value of the performance metric associated with the second content item instance.

21. The computer program product of claim 14, wherein the content comprises one or more selected from a group consisting of: an image, a photograph, text, and any combination thereof.

22. The computer program product of claim 14, wherein the performance metric describes a number of times a content item instance is accessed, a number of times a preference for the content item instance is indicated, a number of installations of an application associated with the content item instance, a number of times an application associated with the content item instance is accessed, a number of purchases of a product associated with the content item instance, a number of purchases of a service associated with the content item instance, a number of views of data associated with the content item instance, a number of conversions associated with the content item instance, a number of subscriptions associated with the content item instance, or a number of interactions with the content item instance.

23. The computer program product of claim 14, wherein the computer readable storage medium further has instructions encoded thereon that, when executed by the processor, cause the processor to:
rank the plurality of content item instances based at least in part on the value of the performance metric associated with each content item instance of the plurality of content item instances;
determine an amount of variation in values of the performance metric associated with the plurality of content item instances;
responsive to determine the amount of variation in values of the performance metric associated with the plurality of content item instances is at least a threshold amount, identify an additional subset of the one or more modifications to the appearance of the content to which the amount of variation in values of the performance metric associated with the plurality of content item instances is attributable; and
predict the improvement in the value of the performance metric associated with content item instances including the additional subset of the one or more modifications based at least in part on the ranking and the amount of variation in values of the performance metric associated with the plurality of content item instances.

24. The computer program product of claim 14, wherein the computer readable storage medium further has instructions encoded thereon that, when executed by the processor, cause the processor to:
store the identifier associated with the set of the one or more modifications to the appearance of the content included in each of the plurality of content item instances in association with each of the plurality of content item instances including the set of the one or more modifications to the appearance of the content.

25. The computer program product of claim 14, wherein the computer readable storage medium further has instructions encoded thereon that, when executed by the processor, cause the processor to:
communicate the predicted improvement in the value of the performance metric associated with content item instances including the subset of the one or more modifications to the content-providing user of the online system.

26. The computer program product of claim 14, wherein the computer readable storage medium further has instructions encoded thereon that, when executed by the processor, cause the processor to:
receive the content from the content-providing user of the online system.

27. A method comprising:
receiving a request from a content-providing user of an online system to generate a content item to be presented to one or more viewing users of the online system, the request specifying one or more modifications to an appearance of content received from the content-providing user;
generating a plurality of content item instances of the content item, each of the plurality of content item instances including a different set of the one or more modifications to the appearance of the content specified in the request;
generating an identifier for each of the plurality of content item instances, each identifier associated with the set of the one or more modifications to the appearance of the content included in the content item instance;
presenting the plurality of content item instances to a subset of the one or more viewing users of the online system;
tracking a performance metric associated with impressions of each of the plurality of content item instances using the identifier associated with the set of the one or more modifications to the appearance of the content included in each of the plurality of content item instances;
ranking the plurality of content item instances based at least in part on a value of the performance metric associated with each content item instance of the plurality of content item instances;
determining an amount of variation in values of the performance metric associated with the plurality of content item instances;
responsive to determining the amount of variation in values of the performance metric associated with the plurality of content item instances is at least a threshold amount, identifying a subset of the one or more modifications to the content to which the amount of variation in values of the performance metric associated with the plurality of content item instances is attributable; and
predicting an effect on the value of the performance metric associated with content item instances as a result of including the subset of the one or more modifications in the content item instances, the effect predicted based at least in part on the ranking and the amount of variation in values of the performance metric associated with the plurality of content item instances.
